(19) United States
(12) Patent Application Publication
(10) Pub. No.: US 2025/0190092 A1
(43) Pub. Date: Jun. 12, 2025

(54) QUALITY CONTROL SYSTEM CONFIGURATION

(71) Applicant: Mclaren Automotive Limited, Woking, Surrey (GB)

(72) Inventor: Phillip KEARNEY, Woking, Surrey (GB)

(73) Assignee: Mclaren Automotive Limited, Woking, Surrey (GB)

(21) Appl. No.: 18/845,528

(22) PCT Filed: Mar. 10, 2023
(86) PCT No.: PCT/GB2023/050568

§ 371 Date: Sep. 10, 2024

(30) Foreign Application Priority Data
Mar. 10, 2022 (GB) 2203345.0

(51) Int. Cl. G06F 3/0482; G06F 3/042; G06Q 10/10; G09B 5/02

(52) U.S. Cl. CPC G06F 3/0482; G06F 3/0425; G06Q 10/103; G09B 5/02

(57) ABSTRACT

A quality control system for guiding an operator in a working environment though a workflow comprising a series of workflow steps. the system comprising: a projector configured to display images on to the working environment: a processor: and a memory storing instructions which when executed by the processor cause the processor to: generate a user interface for display on the working environment using the projector to enable a user to position at least one highlight area within a work area on the working environment: and store the work area including the at least one highlight area positioned in the work area by the user against a workflow step of the workflow.

This application is the National Stage of International Application No. PCT/GB2023/050568 filed Mar. 10, 2023, entitled “QUALITY CONTROL SYSTEM CONFIGURATION,” which claims the benefit and priority of Application No. 2203345.0 filed Mar. 10, 2022, entitled “QUALITY CONTROL SYSTEM CONFIGURATION.” The entirety of each of these applications is hereby incorporated by reference for all purposes.

This invention relates to a quality control system and the configuration of the quality control system.

The manufacture of standardised articles generally follow a workflow. The workflow generally has a series of workflow steps that an operator follows to build the article. It is important that the steps of the workflow are followed in order and with accuracy to enable the article to be built correctly so that the quality control of the articles can be high. The workflow may be written down in a manual that the operator follows to build the article. The manual may also be provided electronically so that it can be viewed on, for example, a computer screen. There is a risk that an operator may get confused by steps that are just written down or shown on a screen. Therefore, the steps of a workflow may be shown on in the working environment used to build the article to allow an operative to follow those steps. This may be shown alongside written instructions shown on a screen to enable the operator to build the article. A quality control system may be provided that presents the information in the working environment.

The programming of the quality control system to present the information to the operative is usually complicated and requires highly skilled users to program the system to present the required information for each workflow step. It would therefore be desirable for there to be an improved method of configuring the quality control system to display the required information for each workflow step.

According to a first aspect of the present invention there is provided a quality control system for guiding an operator in a working environment though a workflow comprising a series of workflow steps, the system comprising: a projector configured to display images on to the working environment; a processor; and a memory storing instructions which when executed by the processor cause the processor to: generate a user interface for display on the working environment using the projector to enable a user to position at least one highlight area within a work area on the working environment; and store the work area including the at least one highlight area positioned in the work area by the user against a workflow step of the workflow.

The instructions when executed by the processor may cause the processor to: receive input from the user via the user interface to position at least one highlight area in the work area. The instructions when executed by the processor may cause the processor to: receive input from the user via the user interface to resize at least one highlight area. The quality control system may store a workflow table for the workflow, and wherein the instructions when executed by the processor may cause the processor to: store the work area against a workflow step of the workflow by storing the work area in a row of the workflow table associated with the workflow step. The instructions when executed by the processor may cause the processor to: store the work area against a workflow step of the workflow by storing a work area identifier for the work area in a row of the workflow table associated with the workflow step.

The system may comprise a user input device configured to permit the user to interact with the user interface. The instructions when executed by the processor may cause the processor to: generate the user interface for display on the working environment using the projector to enable a user to position at least text box within a work area on the working environment. The workflow may guide the operative through building an article. The instructions when executed by the processor may cause the processor to: store the work area against a workflow step in response to receiving input from the user via the user interface to save the work area. The instructions when executed by the processor may cause the processor to: generate a new work area for the user to position highlight areas on in response to receiving input from the user via the user interface to generate a new work area. The instructions when executed by the processor may cause the processor to: store of the work area against the workflow step by generating an image of the work area which includes the highlight area(s) in their respective position(s). The instructions when executed may cause the processor to: load the workflow comprising a series of workflow steps, at least one workflow step having a work area associated with the workflow step; and cause the projector to display on the working environment the work area associated with the respective workflow step in turn in response to input from the operator indicating a workflow step has been completed.

The present invention will now be described by way of example with reference to the accompanying drawings. In the drawings:

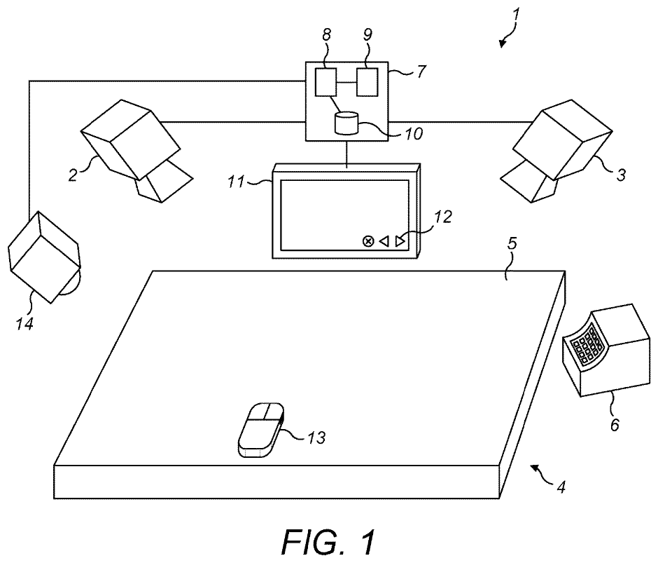

FIG. 1 shows a quality control system.

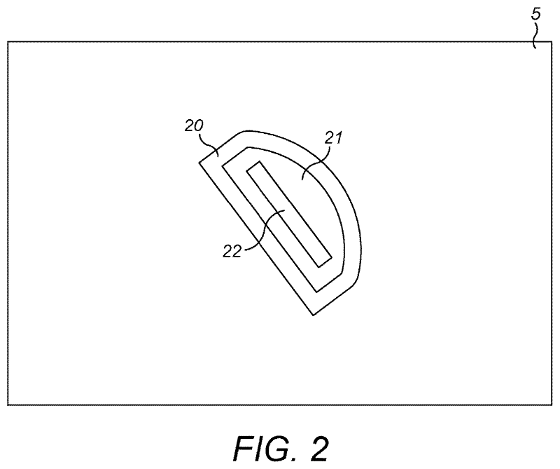

FIG. 2 shows a lay up of carbon fibre material.

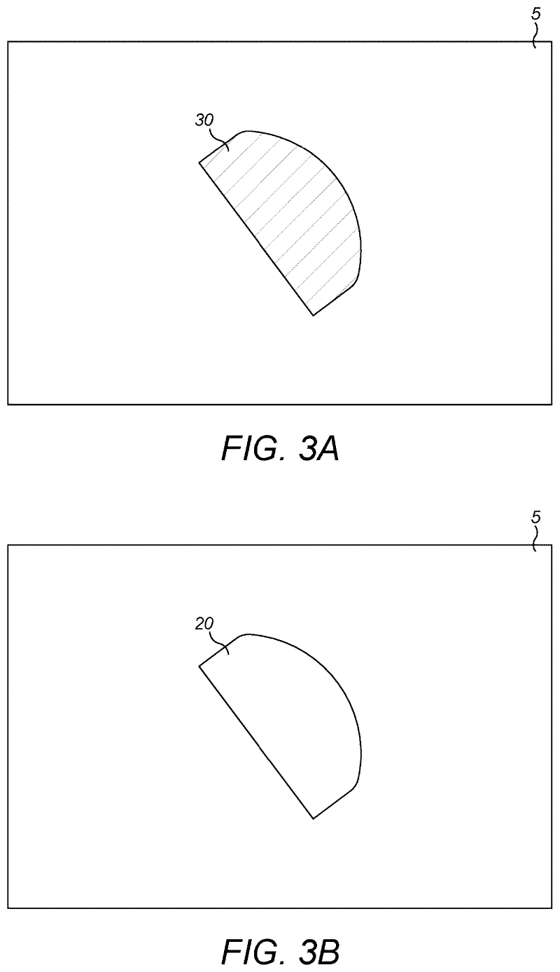

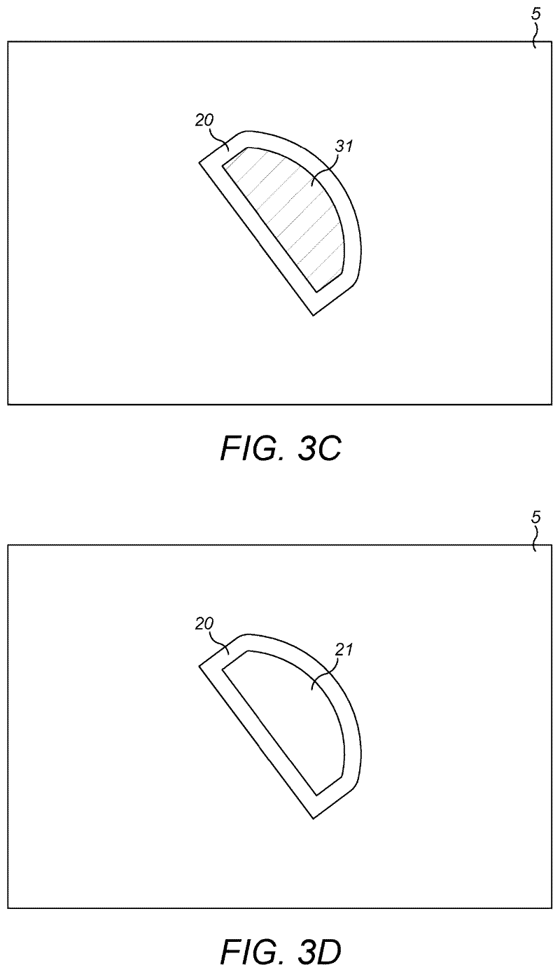

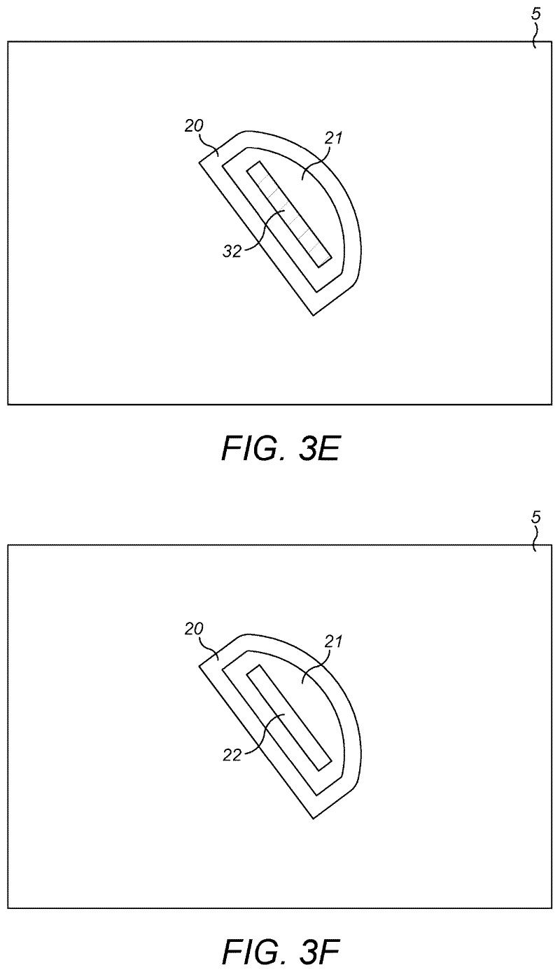

FIG. 3 shows a set of workflow steps that result in the lay up of carbon fibre material.

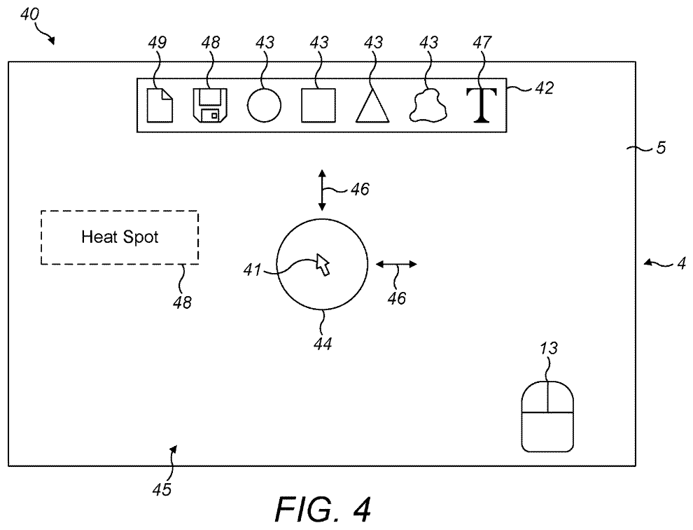

FIG. 4 shows a working environment with a user interface overlaid.

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a quality control system for guiding an operator in a working environment though a workflow comprising a series of workflow steps. The system comprises a projector configured to display images on to the working environment; a processor; and a memory storing instructions. The instructions when executed by the processor cause the processor to: generate a user interface for display on the working environment using the projector to enable a user to position at least one highlight area within a work area on the working environment; and store the work area including the at least one highlight area positioned in the work area by the user against a workflow step of the workflow.

FIG. 1 shows a quality control system 1. The quality control system 1 comprises a first projector 2 and a second projector 3. It will be appreciated that the quality control system 1 may comprise a single projector or plurality of projectors. The quality control system 1 may comprise more than two projectors. The projectors 2, 3 are configured so that they can display images on to a working environment 4.

The working environment 4 is where an operator can build an article. The working environment may comprise a worktable 5 on which components of the article can be placed during the building of the article. The working environment may comprise part stores 6 which store parts that are used to build the article. These part stores 6 may be enclosed receptacles with an opening so that the parts are stored inside the part store 6. In other examples, the part stores 6 may be part trays which store a set of parts of the article in specific locations so that each part can be identified separately by the quality control system 1. A part store 6 may be located in proximity to the worktable 5. A part store 6 may be located on worktable 5. In some examples, the part store may be moveable between a station in proximity to the worktable 5 and the worktable 5.

The quality control system 1 comprises a controller 7. The controller 7 comprises a processor 8 and a memory 9. The controller may comprise a storage location 10. The processor 8 may be a general purpose processor executing software code. A processor 4 executes software code that may be stored in a non-transient way in software memory 9 in order to perform its methods. The software code may be instructions that when executed by the processor cause the processor to undertake the methods of the quality control system 1 described herein. Memory 9 may be a non-volatile memory. The controller 7 can read/write data from/to the storage location 10. The storage location 10 may be in the form of a memory. Storage location 10 may comprise non-volatile memory, may be in the form of an array of discrete banks of memory such as hard disks. Whilst shown in FIG. 1 as schematically being part of controller 7, the storage location 10 may be separate to controller 7 and connected to controller 7.

The quality control system 1 comprises at least one display screen 11. Display screen 11 may also be an input device. For instance, display screen 11 may be a touch screen device. In this way, a user can interface with the quality control system 1 using display screen 11. For instance, the user may use display screen 11 to advance through a set of workflow steps. The display screen 11, under control of the controller 7, may display a user interface 12 to allow the user to interact with the quality control system 1.

The quality control system 1 may comprise one or more input devices 13. These input devices 13 allow a user to interact with the quality control system 1. As pictured in FIG. 1, the input device 13 may be a mouse. The input device 13 may be moved over the worktable 5 to provide input to the quality control system 1. The input device 13 may comprise one or more user actuable switches, such as a button. The quality control system 1 may comprise a motion capture unit 14. The motion capture unit 14 is configured to detect when a user has interacted with the working environment 4. For instance, by touching a particular area of the working environment 4. In this way, the input device 13 may be the working environment 4 itself.

The quality control system 1 is used to guide an operator though a workflow. The quality control system 1 comprises an operation mode. When the quality control system 1 is in the operation mode, the quality control system guides the operator through the workflow. The workflow comprises a series of workflow steps. For instance, a simple workflow may involve the operative laying three pieces of carbon fibre material one on top the other. In FIG. 2, the worktable 5 is shown with the three pieces of carbon fibre material 20, 21, 22 in place on the worktable 5 after the workflow steps have been completed. Whilst the workflow that is illustrated in FIG. 2 shows a number of flat pieces that have been arranged together which are essentially two-dimensional objects, the workflow could equally include the placement of and working with three-dimensional objects and/or a combination of three-dimensional and two-dimensional objects.

FIG. 3 shows the workflow steps that result in the lay up of carbon fibre material 20, 21, 22 that is shown in FIG. 2. The steps shown in FIG. 3 will be described with reference to a single projector but it will be understood that multiple projectors may be used to display images on to the working environment as described herein.

In FIG. 3A, the projector 2 displays a first shape 30 on to the working environment, which in this case is worktable 5. The first shape 30 may be coloured to show that a component is to be placed on the first shape 30. The first shape 30 may match the shape of the first piece of carbon fibre material 20. The display 11 may also provide instructions to the operative about what to do during this workflow step. For instance, the display 11 may tell the operative to place the first piece of carbon fibre material 20 on to the worktable 5 and align it with the first shape 30.

As shown in FIG. 3B, the operative has placed the first piece of carbon fibre material 20 on to the worktable 5 in the position indicated by the first shape 30. For clarity, the first shape 30 has been omitted from FIG. 3B. The first shape 30 would be overlaid on to the first piece 20. The operative may then indicate to the quality control system 1 that the workflow step has been completed successfully. The operative may interact with the quality control system 1 by using the display 11.

In FIG. 3C, the projector 2 displays a second shape 31 on to the working environment, which in this case is worktable 5. The second shape 31 may be coloured to show that a component is to be placed on the second shape 31. The second shape 31 may match the shape of the second piece of carbon fibre material 21. The display 11 may also provide instructions to the operative about what to do during this workflow step. For instance, the display 11 may tell the operative to place the second piece of carbon fibre material 21 on to the worktable 5 and align it with the second shape 31.

As shown in FIG. 3D, the operative has placed the second piece of carbon fibre material 21 on to the worktable 5 in the position indicated by the second shape 31. For clarity, the second shape 31 has been omitted from FIG. 3D. The second shape 31 would be overlaid on to the second piece 21. The operative may then indicate to the quality control system 1 that the workflow step has been completed successfully. The operative may interact with the quality control system 1 by using the display 11.

In FIG. 3E, the projector 2 displays a third shape 32 on to the working environment 4, which in this case is worktable 5. The third shape 32 may be coloured to show that a component is to be placed on the third shape 32. The third shape 32 may match the shape of the third piece of carbon fibre material 22. The display 11 may also provide instructions to the operative about what to do during this workflow step. For instance, the display 11 may tell the operative to place the third piece of carbon fibre material 22 on to the worktable 5 and align it with the third shape 32.

As shown in FIG. 3F, the operative has placed the third piece of carbon fibre material 22 on to the worktable 5 in the position indicated by the third shape 32. For clarity, the third shape 32 has been omitted from FIG. 3F. The third shape 32 would be overlaid on to the third piece 22. The operative may then indicate to the quality control system 1 that the workflow step has been completed successfully. The operative may interact with the quality control system 1 by using the display 11.

The workflow may comprise further steps associated with assembling the carbon fibre material. For instance, heater plates may be used to activate adhesive material in the carbon fibre material to bond the layers together. The quality control system 1 may use the projector to highlight parts that need to be picked up and then used in the assembly process.

Each of the shapes displayed in the working environment may be known as highlight areas. These are areas that the quality control system 1 has been controlled to highlight to an operative for a particular workflow step. The highlight areas are stored as part of a work area for the particular workflow step. The work area is displayed by the projector onto the working environment 4 for a particular workflow step when the operative is undertaking that particular workflow step.

The quality control system 1 may store a workflow table for a particular workflow. The workflow table may be stored in memory 9 and/or in storage area 10. The workflow table may have a row per workflow step. Each row stores a reference to the information that should be presented to an operative for the particular workflow step. The workflow table may store:
A step identifier. The step identifier gives a unique reference for each workflow step. The workflow steps may be nested where a set of workflow steps are related to each other. In this case the workflow step identifier may have a major and a minor reference such as 1.1, 1.2, 1.3, 2.1, 2.2, 3.1.
A step description. The step description is the text-based description of the step the operative needs to undertake. This step description may be displayed on the display 11 and/or projected on to the workspace 4. The workflow table may store the step description. Alternatively, the workflow table may store a reference to the step description. For instance, the workflow table may store a filename for the step description. The quality control system 1 can then access the step description stored in memory 9 and/or storage area 10 with the respective step description reference.
A step media. The step media is a graphical description of the step the operative needs to undertake. This step media may be displayed on the display 11 and/or projected on to the workspace 4. The workflow table may store a reference to the step media. For instance, the workflow table may store a filename for the step media. The quality control system 1 can then access the step media stored in memory 9 and/or storage area 10 with the respective step media reference.
A step work area. The step work area is an image that the projector can display on the working environment. The work area comprises at least one highlight area. The highlight area indicating to the operative a portion of the working environment that the operative needs to interact with during the workflow step. The workflow table may store a reference to the step work area. The reference may be an identifier of the step work area. For instance, the workflow table may store a filename for the step work area. The quality control system 1 can then access the step work area stored in memory 9 and/or storage area 10 with the respective step work area reference.
A step timer. The step timer is a minimum amount of time an operative needs to stay on a particular step in the workflow. The step timer can be advantageous to stop an operative skipping through multiple steps rather than observing each step in turn.

The workflow table may not store a step description, step media and a step work area for every workflow step. For instance, some workflow steps may have a step description that the operative needs to read without interacting with the working environment.

The quality control system 1 loads the workflow table when an operative indicates that they are about to start the workflow within the working environment. For a particular workflow step that is being undertaken by the operative the quality control system 1 loads the respective items listed in that row of the workflow table. For instance, the quality control system 1 loads a step description, a step media and/or a step work area for that workflow step. These are then displayed to the operative in the manner described herein for each item. The quality control system 1 uses the processor 8, memory 9 and/or storage area 10 to undertake these operations.

The creation of the work areas for each workflow step can be a complicated process using traditional techniques. This can tend to involve programming knowledge to generate the required highlight areas within each work area. Such a process means that it is time consuming to create the workflows and requires a user with specialist knowledge to create the workflows. An improved method of configuring the workflows of the quality control system 1 is described with reference to FIG. 4. FIG. 4 shows a working environment with a user interface overlaid.

The quality control system 1 comprises a configuration mode. When the quality control system 1 is in the configuration mode, the system can be used to generate the work areas for the workflow steps. The system 1 generates a user interface 40. The user interface 40 is displayed on the working environment 4. The user interface 40 is displayed on the working environment 4 by the projector 2. A user can interact with the user interface 40 by using a user input device 13. The user input device 40 may be a physical object that can be interacted with to control the position of a cursor 41 on the user interface 40. Alternatively, or as well as, the user may be able to interact directly with the user interface 40 by touching the working environment 4. The working environment 4 may be touch sensitive. As described herein, the quality control system 1 may comprise a motion capture unit 14. The motion capture unit 14 is configured to detect when a user has interacted with the working environment 4. For instance, by touching a particular area of the working environment 4. In this way, the input device 13 may be the working environment 4 itself.

The user interface 40 comprises a menu bar 42. The menu bar 42 permits a user to select one or more shapes 43 of highlight area to be included in the work area 45. The user can select a shape 43 of highlight area by interacting with the button of the user interface associated with that particular shape 43. The user interface 42 comprises a plurality of shapes of highlight area 44 that can be selected. For instance, the shape may be a circle, a square, a triangle or an irregular shape that can be configured by the user.

In the example shown in FIG. 4, the user has selected a round highlight area 44. The user interface 40 therefore places a highlight area 44 within the work area 45. The user can then interact with the highlight area 44 to position the highlight area 44 in the correct place for that workflow step. This is as illustrated by arrows 46. For instance, the round highlight area 44 may designate where to place a heater during that workflow step. The user can interact with the highlight area 44 to change its size. This may be done by using the user interface 40 to command the quality control system to adjust the size of the highlight area 44.

The user interface 40 may also permit a user to add text to the work area 45. The menu bar 42 permits a user to select a text box 47 to be included in the work area 45. FIG. 4 shows one text box 48 having been placed in the work area 45 by the user interface 40. The user can add whatever text is required to assist the operative in undertaking the step of the workflow. In this instance, the text box 48 says “heat spot” which provides guidance to the operative to apply a heater to the highlight area 44.

By interacting directly with the quality control system 1 to position the highlight areas, and other objects such as text boxes as required, that the operative needs to interact with, the system can be configured efficiently and quickly by a user who is skilled in the workflow that needs to be completed but does not need to be skilled in programming a computer system. This is advantageous because it reduces the time required to produce the workflow and the workflow steps. It also reduces the likelihood of mistakes in the workflow as the user who can build them can be skilled in the workflow rather than skilled in programming a quality control system.

Once the user has positioned the one or more highlight areas in the work area for a particular workflow step together with any other objects, the user can use the user interface 40 to store the work area against the particular workflow step of the workflow. This may be done by interacting with the save button 48 in the menu bar 42. The storing of the work area against the workflow step may comprise generating an image of the work area which includes the highlight area(s) in their respective position(s). The image is capable of being displayed by the projector(s) on to the working environment. The projector(s) can display the work area when the relevant workflow step is reached. The storing of the work area against the workflow step may comprise storing the work area file with a particular identifier which is linked to the workflow step. For instance, the work area file may be stored with as the step work area. The identifier that is associated with the work area file may be stored in the row of the workflow table associated with that workflow step.

The user can generate a new work area by interacting with the user interface 40. For instance the user may interact with the new work area button 49 in the menu bar 42. The user interface 40 may prompt the user to designate the workflow step that the step work area is associated with.

Once the workflow is completed, an operative can use the quality control system to be guided through the workflow. The quality control system 1 is configured to load the workflow comprising a series of workflow steps. At least one of the workflow steps has a respective work area associated with it for projection on the working environment. The workflow may comprise multiple workflow steps that have a respective work areas associated with them. Some workflow steps may have the same work area associated with them. Some workflow steps may have no work area associated with them.

The quality control system 1 is configured to cause the projector to display on the working environment the work area associated with a respective workflow step. Each work area is displayed in turn according to its associated workflow step. In response to an operative indicating that a workflow step has been completed, the next workflow step is loaded and if that workflow step has a work area associated with it then the projector is caused to display the work area on the working environment. As described herein, the respective work areas comprise at least one highlight area. The highlight area(s) may be in different positions in at least some of the workflow steps. The highlight area(s) may be in different positions in all of the workflow steps. In this way, an operative can be guided through the workflow using the quality control system 1.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A quality control system for guiding an operator in a working environment though a workflow comprising a series of workflow steps, the system comprising:
a projector configured to display images on to the working environment;
a processor; and
a memory storing instructions which when executed by the processor cause the processor to:
generate a user interface for display on the working environment using the projector to enable a user to position at least one highlight area within a work area on the working environment; and
store the work area including the at least one highlight area positioned in the work area by the user against a workflow step of the workflow.

2. The system according to claim 1, wherein the instructions when executed by the processor cause the processor to: receive input from the user via the user interface to position at least one highlight area in the work area.

3. The system according to claim 1, wherein the instructions when executed by the processor cause the processor to: receive input from the user via the user interface to resize at least one highlight area.

4. The system according to claim 1, wherein the quality control system stores a workflow table for the workflow, and wherein the instructions when executed by the processor cause the processor to: store the work area against a workflow step of the workflow by storing the work area in a row of the workflow table associated with the workflow step.

5. The system according to claim 4, wherein the instructions when executed by the processor cause the processor to: store the work area against a workflow step of the workflow by storing a work area identifier for the work area in a row of the workflow table associated with the workflow step.

6. The system according to claim 1, the system comprising a user input device configured to permit the user to interact with the user interface.

7. The system according to claim 1, wherein the instructions when executed by the processor cause the processor to: generate the user interface for display on the working environment using the projector to enable a user to position at least text box within a work area on the working environment.

8. The system according to claim 1, wherein the workflow guides the operative through building an article.

9. The system according to claim 1, wherein the instructions when executed by the processor cause the processor to: store the work area against a workflow step in response to receiving input from the user via the user interface to save the work area.

10. The system according to claim 1, wherein the instructions when executed by the processor cause the processor to: generate a new work area for the user to position highlight areas on in response to receiving input from the user via the user interface to generate a new work area.

11. The system according to claim 1, wherein the instructions when executed by the processor cause the processor to: store of the work area against the workflow step by generating an image of the work area which includes the highlight area(s) in their respective position(s).

12. The system according to claim 1, wherein the instructions when executed cause the processor to:
load the workflow comprising a series of workflow steps, at least one workflow step having a work area associated with the workflow step; and
cause the projector to display on the working environment the work area associated with the respective workflow step in turn in response to input from the operator indicating a workflow step has been completed.

13. The system according to claim 2, wherein the instructions when executed by the processor cause the processor to: receive input from the user via the user interface to resize at least one highlight area.

14. The system according to claim 13, the system comprising a user input device configured to permit the user to interact with the user interface.

15. The system according to claim 14, wherein the instructions when executed by the processor cause the processor to: store the work area against a workflow step in response to receiving input from the user via the user interface to save the work area.

16. The system according to claim 15, wherein the instructions when executed by the processor cause the processor to: generate a new work area for the user to position highlight areas on in response to receiving input from the user via the user interface to generate a new work area.

17. The system according to claim 16, wherein the instructions when executed by the processor cause the processor to: store of the work area against the workflow step by generating an image of the work area which includes the highlight area(s) in their respective position(s).
